(19) United States
(12) Patent Application Publication
(10) Pub. No.: US 2025/0379020 A1
(43) Pub. Date: Dec. 11, 2025

(54) FIELD EFFECT EMITTER MICROSTRUCTURE HAVING A REDUCED GATE CURRENT

(71) Applicant: Siemens Healthineers AG, Forchheim (DE)

(72) Inventors: Christoph JUD, Nuernberg (DE); Peter GEITHNER, Erlangen (DE); Anja FRITZLER, Erlangen (DE)

(73) Assignee: Siemens Healthineers AG, Forchheim (DE)

(21) Appl. No.: 19/230,341

(22) Filed: Jun. 6, 2025

(30) Foreign Application Priority Data
Jun. 7, 2024 (DE) 10 2024 205 266.3

(51) Int. Cl. H01J 35/06; H01J 35/14

(52) U.S. Cl. CPC H01J 35/065; H01J 35/14; H01J 2235/062

(57) ABSTRACT

A field effect emitter microstructure comprises: an emitter needle having a field effect emitter portion on a first end; a gate electrode with a gate opening connecting an underside of the gate electrode facing the emitter needle to an upper side of the gate electrode facing away from the underside, wherein a central axis of the emitter needle is perpendicular to the gate electrode toward the gate opening in the emitting direction; and a first insulating layer adjoining the emitter needle under the field effect emitter portion and at least partially adjoining the gate electrode underside. An emission voltage is applied to produce free electrons in the field effect emitter portion. The first end of the emitter needle has a protrusion greater than or equal to zero relative to the gate electrode upper side and/or the first insulating layer adjoins the inner wall of the gate opening.

### CROSS-REFERENCE TO RELATED APPLICATION(S)

The present application claims priority under 35 U.S.C. § 119 to German Patent Application No. 10 2024 205 266.3, filed Jun. 7, 2024, the entire contents of which are incorporated herein by reference.

### FIELD

One or more example embodiments of the present invention relate to a field effect emitter microstructure, an electron emitter apparatus, an X-ray tube and a method for generating X-ray beams via an X-ray tube.

### BACKGROUND

Field effect emitter microstructures as electron sources in a vacuum are known in principle. In particular, when used as electron emitters in evacuated X-ray tubes, field effect emitter microstructures are advantageous due to their rapid switching capability, the possibility of a pixelation of the emitting surface and/or, depending upon the configuration, the relatively high electron emission current density. By way of example, Guerrera et al. described silicon field effect emitter microstructures with an electron emission density of over 100 A/cm\hat{ }2 in “Silicon Field Emitter Arrays With Current Densities Exceeding 100 A/cm\hat{ }2 at Gate Voltages Below 75 V” (IEEE ELECTRON DEVICE LETTERS, VOL. 37, NO. 1, January 2016).

A typical problem in the operation of field effect emitter microstructures is, in particular, the current flowing away via the gate electrode, formed by a portion of the electrons flowing through the emitter needles. The cause of this gate current is, for example, an electrically conductive contact between a gate electrode of the field effect emitter microstructure and an emitter needle of the field effect emitter microstructure due to a faulty production process and/or mechanical damage. Alternatively or additionally, impurities can connect emitter needles to the gate electrode. Due to excessive currents through individual emitter needles, damage in the form of a conductive connection to the gate electrode can occur. Such conductive connections can alternatively or additionally arise from high voltage arcing to the field effect emitter microstructure. A further example relates thereto that a gate current can form without a direct conductive connection between the gate electrode and the emitter needle, specifically through a scattering of the emitted electrons, wherein a portion of the scattered electrons flows away via the gate electrode.

A high voltage arcing typically has the following optional effects:
the gate electrode can evaporate so that no emission voltage relative to the emitter needles situated thereunder can build up. In this case, an undamaged portion of the field effect emitter microstructure can advantageously continue to produce free electrons.
the gate electrode can melt and the gate openings can close so that electrons produced on the emitter needles situated thereunder are incident upon the melted gate electrode which can thus ultimately evaporate.
the gate electrode can melt and create an electrically conductive connection to an emitter needle so that no emission voltage can build up between the gate electrode and typically all the emitter needles due to the electrical short, such that the entire field effect emitter microstructure typically can produce no further electrons.

R. F. Asadi, T. Zheng, J. Da Silva, G. Rughoobur, A. I. Akinwande and B. Gnade, describe in “Failure Mode of Si Field Emission Arrays based on Emission Pattern Analysis,” 2021, 34th International Vacuum Nanoelectronics Conference (IVNC), Lyon, France, 2021, pp. 1-2, doi: 10.1109/IVNC52431.2021.9600740, that in principle individual faults, in particular, previously described instances of damage often have negative effects on the entire field effect emitter microstructure, since the emission voltage is usually impaired.

### SUMMARY

It is an object of one or more example embodiments of the present invention to provide a field effect emitter microstructure, an electron emitter apparatus, an X-ray tube and a method for generating X-ray beams via an X-ray tube with a reduced gate current.

At least this object is achieved with the features of the independent claims. Advantageous embodiments are disclosed in the subclaims.

The field effect emitter microstructure, according to embodiments of the present invention, for an X-ray tube has
an emitter needle, wherein the emitter needle has a field effect emitter portion on a first end,
a gate electrode with a gate opening, wherein the gate opening connects an underside of the gate electrode facing toward the emitter needle to an upper side of the gate electrode facing away from the underside, wherein the longitudinal central axis of the emitter needle is oriented perpendicularly to the gate electrode toward the gate opening in the emitting direction, and
a first insulating layer which adjoins the emitter needle at least underneath the field effect emitter portion and at least partially adjoins the underside of the gate electrode,
wherein via an emission voltage that can be applied between the gate electrode and the field effect emitter portion, free electrons can be produced in the field effect emitter portion, and is characterized in that
the first end of the emitter needle has a protrusion greater than or equal to zero relative to the upper side of the gate electrode, and/or
the first insulating layer adjoins the inner wall of the gate opening.

The electron emitter apparatus, according to embodiments of the present invention, has
a field effect emitter microstructure and
a voltage source connected to the field effect emitter microstructure for providing an emission voltage and/or a focusing voltage.

The X-ray tube, according to embodiments of the present invention, has
a housing with an internal space that is able to be evacuated,
an electron emitter apparatus in the internal space, and
an anode in the internal space for generating X-ray beams dependent upon free electrons able to be produced via the electron emitter apparatus.

The method, according to embodiments of the present invention, for generating X-ray beams via an X-ray tube comprises the steps:
applying an emission voltage between the gate electrode and the emitter needle in order to produce free electrons,
applying a focusing voltage between the focusing layer and the gate electrode for focusing the free electrons,
generating X-ray beams via the anode of the X-ray tube by way of an interaction with the focused free electrons.

An advantage of one or more example embodiments of the present invention is that, if the protrusion is greater than or equal to zero and/or the first insulating layer adjoins the inner wall of the gate opening, the gate current can be reduced. In particular, the greater the protrusion is, the more strongly the gate current is reduced. In this manner, advantageously, a melting of the gate electrode can be reduced or entirely prevented. Advantageously, despite the protrusion, on application of the emission voltage, free electrons can be produced in the field effect emitter portion. One or more example embodiments of the present invention therefore advantageously enables a reduction of the gate current flowing away via the gate electrode due to the increased spacing of the free electrons from the gate electrode, which increases the likelihood that the free electrons are drawn toward, and/or accelerated away from, the anode.

The fact that the first insulating layer adjoins the inner wall of the gate opening, further advantageously enables a reduction or even a complete prevention of short circuits between the emitter needle and the gate electrode. Thus, a field effect emitter microstructure configured in this way is more robust with respect to arcing and/or production inaccuracies.

The field effect emitter microstructure is suitable for an X-ray tube such that electrons produced via the field effect emitter microstructure form quantitative tube currents in a vacuum that are sufficient for imaging and/or a therapeutic application using the X-ray radiation generated at the anode. At the focal point on the anode, dependent upon the use, a current density of up to approximately 10 A/cm\hat{ }2 is necessary. Conventional thermionic emitters have current densities of approximately 3 A/cm\hat{ }2, so that the conventional thermionic emitter cannot be directly mapped onto the focal point. However, field effect emitter microstructures, according to embodiments of the present invention, can have emitting surfaces which reach current densities of, for example, of up to 100 A/cm\hat{ }2. A direct mapping would therefore be possible in principle, for example, via a suitable focusing. The imaging can be, in particular, a computed tomography, an angiography, a mammography, a conventional radiography, an image-assisted material testing and/or an image-assisted customs check. The therapeutic use of the X-ray beams can be, in particular, a radiotherapy.

The field effect emitter microstructure substantially relates to an arrangement of microstructure components, in particular, the emitter needle, the gate electrode and the first insulating layer relative to one another. In particular, the field effect emitter microstructure has structures in the micrometer range or the nanometer range. The field effect emitter microstructure is, in particular, a microstructure component. The field effect emitter microstructure can be a semiconductor component. The field effect emitter microstructure can be produced, in particular, by a semiconductor manufacturer.

A field effect emitter microstructure with only a single emitter needle is usually smaller by at least one order of magnitude in its dimensions, in comparison with a conventional thermionic electron emitter. A field effect emitter microstructure with a plurality of emitter needles, in particular, with a large number of emitter needles, can have substantially the same dimensions as a conventional thermionic electron emitter.

The field effect emitter microstructure has, in particular, connections for a tapping off of the emission voltage and/or the focusing voltage. For example, the gate electrode can have a terminal for tapping off a first potential of the emission voltage. For example, the emitter needle and/or an electrical feed to the emitter needle can have a terminal for tapping off a second potential of the emission voltage. If the field effect emitter microstructure has a focusing layer, the first focusing layer typically has a terminal for tapping off a first potential of the focusing voltage. Dependent upon the reference point of the focusing voltage, the terminal of the emitter needle or the terminal of the gate electrode can tap off a second potential of the focusing voltage. According to the definition, the focusing voltage is applied between the focusing layer and the gate electrode.

The voltage source of the electron emitter apparatus can preferably generate the emission voltage and/or the focusing voltage and provide it at the terminals of the field effect emitter microstructure. For the provision, the voltage source can have feeds, in particular feed lines and/or conductor tracks. The voltage generated is applied by way of the provision of a generated voltage at the terminals.

The housing of the X-ray tube typically comprises metal and/or glass. The housing of the X-ray tube can typically be tempered via a medium which interacts with the exterior of the housing during operation of the X-ray tube, preferably cooled and/or electrically insulated. The housing of the X-ray tube is, in particular, high voltage resistant. The internal space of the housing can be evacuated. The housing can have an apparatus, for example, a housing opening and/or a valve, in order to evacuate the internal space. The vacuum in the internal space is typically a hard vacuum. The electron emitter apparatus and the anode are typically arranged opposite one another in the internal space.

Between the anode and the electron emitter apparatus which typically forms the cathode, there is typically a high voltage for accelerating the free electrons. The high voltage can be, for example, up to 200 kV, typically between 20 and 150 kV. The high voltage is typically generated by a high voltage source and/or is provided at the anode and/or cathode. After acceleration, the electrons interact with the anode in order to generate the X-ray beams. The anode can be, in particular, a rotating anode or a stationary anode. Alternatively, it is conceivable that the anode is rotatably mounted together with the housing. In this event, the anode and the housing are typically connected to one another for conjoint rotation. The anode can advantageously have a series resistor connected upstream of it in order to limit a short-circuit current through the focusing layer.

The emitter needle is, in particular, a field effect emitter. The emitter needle is typically a nano-structure or micro-structure component. The emitter needle can alternatively be designated a nanotubule. Also known, for example, is the expression carbon nano-tube for emitter needles made of carbon. The emitter needle is typically electrically conductive and/or is a semiconductor. The emitter needle can consist of carbon or silicon or another material. Preferably, the emitter needle is configured in the manner described by Guerrera et al. as a silicon emitter needle.

The emitter needle is an elongate and narrow column. The emitter needle can typically be subdivided into two functional portions. Arranged at the first end is the field effect emitter portion, from where electrons can emerge from the emitter needle via the field effect, in order to remove them as free electrons from the emitter needles. Arranged at the second end, for example, is a connecting portion which serves for conducting the electrons from a current source to the field effect emitter portion and typically does not and/or hardly contributes to the electron emission. The connecting portion can be configured, in particular, for feeding an electrical potential of the emission voltage to the field effect emitter portion. The emitter needle can additionally have a current limiting unit which is arranged, in particular, upstream of the field effect emitter portion, for example, between the field effect emitter portion and the connecting portion in order to be able to limit the current flow through the emitter needle. In particular, the current limiting unit can be a transistor or another switch. The current limiting unit can be arranged at the second end of the emitter needle.

The emitter needle can be, in particular, rod-like. The emitter needle can typically be subdivided into two geometric portions, in particular, a portion with a constant, in particular, round or polygonal cross-section and a pointed portion. The connecting portion is typically part of the cylindrical portion. The field effect emitter portion is typically part of the pointed portion. Typically, most of the electrons emerge from the outermost tip and/or the region adjacent to the outermost tip of the pointed portion of the emitter needle. The angle enclosed by the pointed portion and the longitudinal central axis can be, for example, 30°.

The emitting direction of the emitter needle is typically along the longitudinal central axis of the emitter needle. The emitting direction is typically away from the field effect emitter portion in the direction toward the focusing layer. The emitting direction is indicated, in particular, by the pointed portion of the emitter needle.

The gate electrode is, in particular, a gate electrode layer. The gate electrode is electrically conductive and, in particular, made of a metal or a doped metal onto which a metallic cover layer can be applied.

In particular, the gate electrode has the gate opening, the underside facing toward the emitter needle and the upper side facing away from the underside. The gate opening is a hollow space which connects in particular the underside of the gate electrode to its upper side and/or is delimited by an inner wall of the gate electrode. The gate opening is preferably enveloped by the inner wall of the gate electrode.

In the following, the expression diameter is used assuming that the diameter is, in principle, defined in the plane of the respective layer and that with non-round items, in particular openings, what is meant is the maximum diameter. To the extent that items, for example, openings have diameters varying perpendicularly to the respective layer, for example, in the emitting direction and/or along the longitudinal central axis of the emitter needle, the diameter relates, if not otherwise stated, to a mean diameter, formed from the (maximum) location-dependent, varying diameters. The mean diameter is, in particular, an arithmetic mean value.

The gate opening is preferably configured rotationally symmetrical. The gate opening preferably comprises a cylindrical volume. In particular, the gate opening has a circular cross-section. Typically, a diameter of the gate opening is greater than a diameter transverse to the longitudinal central axis of the emitter needle. The gate opening is configured, in particular, for a passage of the free electrons.

The gate electrode is oriented, in particular, perpendicularly to the emitter needle such that the longitudinal central axis of the emitter needle preferably intersects the cross-section of the gate opening centrally. The gate electrode and the emitter needle are arranged in an approximately T-shaped form. The emitter needle, in particular, forms the long limb which divides the gate electrode centrally in the gate opening into approximately two small limbs. The gate electrode and the emitter needles are arranged not electrically connected to one another. The emitter needle and/or the longitudinal central axis of the emitter needle intersects the gate electrode in its gate opening, in particular without an electrically conductive connection. Preferably, the central axis of the gate opening and the longitudinal central axis of the emitter needle coincide.

In the present application, adjoining means that an item, in particular a layer which adjoins another item, in particular another layer is in full-surface contact with and touching this other item. Mutually adjacent items and/or layers typically have no hollow space between them, but rather if at all, minimal intermediate spaces in the nanometer or micrometer range as a result of production techniques.

The fact that an item, in particular a layer, at least partially adjoins another item, in particular, another layer includes, in particular, that the other item at least partially adjoins the item and can mean that the other item adjoins the item completely. In other words, it depends upon the dimensions and/or the respective arrangement of the items and/or the layers relative to one another, whether, according to the perspective, one adjoins the other only partially and the other adjoins the one completely. When assessing whether a partial or complete adjacency has occurred, in the present application, the regions around the gate opening, in particular, and/or the respective through opening is considered. The degree of adjacency describes, in particular, a portion of the coverage and, in particular, not a quality of the connection to one another.

The first insulating layer is suitable, in particular, for an electrical insulation of the emitter needle in relation to the gate electrode and vice versa. The first insulating layer does not usually couple the emitter needle and the gate electrode conductively, but primarily mechanically.

The first insulating layer consists, for example, of silicon dioxide. The first insulating layer consists, in particular, of an electrically non-conductive and/or a dielectric material. The first insulating layer is, in particular, a body by way of which the emitter needle can be oriented relative to the gate electrode without thereby generating an electrical connection between them. The first insulating layer can be designated an insulating matrix.

With regard to the T-shaped arrangement of the gate electrode and the emitter needle, the first insulating layer fills, in particular, the half spaces underneath the short limbs of the gate electrode as far as the emitter needle. Conventionally, the cylindrical portion of the emitter needle is typically surrounded completely by the first insulating layer. In principle, it is conceivable that the pointed portion of the emitter needle at least partially adjoins the first insulating layer.

It is possible that the first insulating layer extends beyond the gate electrode or vice versa. The first insulating layer has the upper side facing toward the gate electrode and the underside facing away from the upper side. The fact that the first insulating layer at least partially adjoins the underside of the gate electrode means, in particular, that the upper side of the first insulating layer to a certain extent does not adjoin the underside of the gate electrode. The underside of the gate electrode can adjoin the upper side of the first insulating layer completely. It is conceivable that a closed region on the underside of the gate electrode adjoining the gate opening is not covered by the first insulating layer and thus does not adjoin the first insulating layer. In other words, a frame of the gate opening on the underside can remain free. Alternatively, dependent upon the embodiment, it is conceivable that the first insulating layer adjoins the underside of the gate electrode as far as the gate opening.

The emitter needle is embedded at least underneath the field effect emitter portion into the first insulating layer. Embedded means a full-surface adjoining of one another.

The emission voltage can be, in particular, between greater than zero and smaller than or equal to 1000 V, in particular between 1 V and 100 V, preferably 50 V. The electric potential of the field effect emitter portion is typically more negative during the electron emission than the electric potential of the gate electrode. It is conceivable that the electric potential of the gate electrode is 0 V or is negative. By way of the application of the emission voltage, in the field effect emitter portion, electrons normally emerge from the emitter needle.

The protrusion of the first end relates, in particular, to the highest position of the emitter needle in the emitting direction. Typically, the outermost end of the emitter needle has the highest position of the emitter needle relative to the emitting direction, thus in particular, the end of the pointed portion. The protrusion is, for example, between 0.001 μm and 1 μm, in particular between 0.01 μm and 0.4 μm

In the event that a protrusion is equal to zero relative to the upper side, the first end of the emitter needle ends, in particular, flush with the upper side of the gate electrode. In this case, the first end of the emitter needle protrudes into the gate opening but not beyond the gate opening. With a protrusion equal to zero, there is, in particular, no protrusion. In the event of a protrusion equal to zero, in particular, the upper side of the gate electrode relative to the first end of the emitter needle has no protrusion. In the event of a protrusion equal to zero, the upper side of the gate electrode and the first end of the emitter needle are, in particular, of equal height.

In the event of a protrusion greater than zero relative to the upper side, the first end of the emitter needle is arranged above the upper side of the gate electrode. In this case, the first end of the emitter needle protrudes into the gate opening and beyond the gate opening. In this variant, in particular, due to the positive protrusion, production of the field effect emitter microstructure is more challenging.

The inventors have recognized that, despite the protrusion, free electrons can be produced in the field effect emitter portion on application of the emission voltage. This variant advantageously enables a reduction of the gate current flowing away via the gate electrode due to the increased spacing of the free electrons from the gate electrode, which increases the likelihood that the free electrons are drawn toward, and/or accelerated away in the direction of the anode.

A variant of one or more example embodiments of the present invention provides that the first insulating layer adjoins an inner wall of the gate opening. The first insulating layer extends, in particular, into the gate opening. It is advantageous if the first insulating layer adjoins the inner wall of the gate opening in an annular manner and has a through opening for the free electrons and/or the emitter needle. Typically, the first insulating layer adjoins the inner wall of the gate opening continuously from the underside of the gate electrode. It is conceivable that the first insulating layer covers only a part of the thickness, that is the extent of the gate opening in the emitting direction, in particular, starting from the underside of the gate electrode. Alternatively, the first insulating layer can cover the inner wall of the gate opening along the entire thickness and/or only beginning from the upper side of the gate electrode and/or only centrally.

An embodiment provides that the first insulating layer adjoins the sides of the field effect emitter portion. The first insulating layer adjoins the field effect emitter portion, in particular, in the circumferential direction. The embodiment is advantageous, in particular, since thereby the gate current can be further reduced. It is conceivable that the field effect emitter portion adjoins the first insulating layer only partially, or completely. In particular, the field effect emitter portion can be completely embedded in the first insulating layer. In this case, a part of the field effect emitter portion can advantageously be burned free by applying a voltage. The voltage can, in principle, correspond quantitatively with the emission voltage or can deviate therefrom. It is conceivable that for the burning free, for a longer period than without the burning free, the voltage, for example, the emission voltage is applied. Burning free means, in particular, an increase in the electrical charge in the region of the first insulating layer adjoining the field effect emitter portion, so that by way of thermal effects due to the electric charge, the material of the first insulating layer is removed. This development of this embodiment is advantageous, in particular, in order to maximize the electrical insulation of the emitter needle to lessen the gate current. In particular, the method, according to embodiments of the present invention, can have the following method step, that before the emission voltage, a voltage is applied between the gate electrode and the emitter needle for a burning free of at least a part of the field effect emitter portion.

An embodiment provides that the first insulating layer has a cut-out with a partially constant cross-section in which the emitter needle is arranged. The cross-section can be, in particular, round or polygonal. The cut-out can be, in particular, partially cylindrical. In particular, the cut-out can be configured geometrically in accordance with the emitter needle.

An embodiment provides that the first insulating layer has a cut-out at the height of the field effect emitter portion with a portion having a larger diameter than a portion underneath the field effect emitter portion. In this case, the first insulating layer is configured expanding, in particular, in the emitting direction. This embodiment can be advantageous in order to reduce the quantity of free electrons that charge the first insulating layer.

An embodiment provides that the emitter needle has a pointed portion, wherein the field effect emitter portion is part of the pointed portion, wherein the pointed end of the pointed portion is arranged above the upper side of the gate electrode and wherein the broad end of the pointed portion that faces away from the pointed end is arranged underneath the underside of the gate electrode. In other words, in particular, the gate opening and the field effect emitter portion is oriented centrally in relation to the emitting direction.

An embodiment provides that the field effect emitter microstructure further has:
a second insulating layer with an underside facing toward the emitter needle and an upper side facing away from the underside,
an electrically conductive focusing layer with an underside facing toward the emitter needle and an upper side facing away from the underside,
wherein the underside of the second insulating layer at least partially adjoins the upper side of the gate electrode,
wherein the upper side of the second insulating layer at least partially adjoins the underside of the focusing layer,
wherein the second insulating layer and the focusing layer each have a through opening for the free electrons that can be produced in the field effect emitter portion.

An advantage of this embodiment is that the free electrons can be focused via the focusing layer. In this case, the conventional deflecting unit for an electrostatic or electromagnetic focusing of the electrons can preferably be dispensed with. The focusing layer is particularly advantageous due to its spatial proximity to the field effect emitter portion as compared with a conventional deflecting unit and is therefore particularly suitable for the focusing. Close to the field effect emitter portion, the focusing of the electrons can be achieved via a small electric field component in the focusing direction as compared with a conventional focusing voltage, in particular, since they still have a low speed. Preferably, a sufficient focusing with moderate focusing voltages can be achieved while the main component of the field causes an acceleration of the electrons.

A further advantage is that, by way of the focusing, a portion of the free electrons conventionally flying toward the gate electrode is deflected and thereby the gate current is reduced. This is advantageous, in particular, for embodiments in which the current of the free electrons is maximized at up to 100 A/cm\hat{ }2. This advantage applies, in particular, for field effect emitter microstructures with emitter needles made of silicon as compared with field effect emitter microstructures with emitter needles made of carbon, wherein the latter typically have an externally placed grid electrode at a greater separation from the emitter needles.

A further advantage of this embodiment relates thereto that the focusing layer rather than the gate electrode is exposed to the anode as compared with a conventional field effect emitter microstructure. From this it advantageously follows that, in the event of a voltage arcing from the anode to the field effect emitter microstructure, primarily the focusing layer is damaged. At least the likelihood that the voltage arcing affects the focusing layer and not the gate electrode and/or the emitter needle is significantly increased. Ideally, such a voltage arcing therefore does not have any effect, or only a relatively large arcing has an effect on the gate electrode. If the focusing layer is damaged, typically only the focusing of the electrons is impaired or prevented. This is in contrast to the damage of the gate electrode of a conventional field effect emitter microstructure which can lead to the failure of the entire field effect emitter microstructure. For example, a melted-on focusing layer would still have to bridge the insulating route along the second insulating layer before the arcing can exert an indirect negative influence on the gate electrode and/or the emitter needle.

A further advantage of one or more example embodiments of the present invention is that the focusing layer can be configured with practically any desired thickness in order to have a high thermal loading capacity, as can be needed in the event of voltage arcing. Advantageously, the currents occurring in the case of a voltage arcing can be conducted away without damage to the field effect emitter microstructure.

The second insulating layer has the underside that faces toward the emitter needle and the upper side that faces away from the underside and also the through opening which connects the upper side of the second insulating layer and the underside of the second insulating layer. The second insulating layer preferably at least partially covers the gate electrode. It is conceivable that a closed region on the upper side of the gate electrode and adjoining the gate opening is not covered by the second insulating layer and thus does not adjoin the second insulating layer. In other words, a frame of the gate opening on the upper side can remain free. Alternatively, dependent upon the configuration, it is conceivable that the second insulating layer adjoins the upper side of the gate electrode such that the through opening of the second insulating layer and the gate opening have the same diameter and their central axes coincide.

The through opening of the second insulating layer is delimited by an inner wall of the second insulating layer. The through opening of the second insulating layer is preferably enveloped by the inner wall of the second insulating layer. The through opening of the second insulating layer is configured, in particular, for a passage of the free electrons.

The second insulating layer can consist, in particular, of silicon dioxide. The second insulating layer consists, in particular, of an electrically non-conductive, and/or a dielectric, material. The first insulating layer and the second insulating layer can consist of the same material. Typically, the first insulating layer is more voluminous than the second insulating layer. The second insulating layer typically has a thickness that is smaller than a thickness of the first insulating layer. The second insulating layer has, in particular, a breakdown strength of at least 100 V/μm, preferably at least 400 V/μm.

The focusing layer is, in particular, a focusing electrode. The focusing layer has the underside that faces toward the emitter needle and the upper side that faces away from the underside, and also the through opening which connects the upper side of the focusing layer and the underside of the focusing layer. Advantageously, the focusing layer covers the upper side of the second insulating layer completely. The through opening of the focusing layer is delimited by an inner wall of the focusing layer. The through opening of the focusing layer is preferably enveloped by the inner wall of the focusing layer. The through opening of the focusing layer is configured, in particular, for a passage of the free electrons. A focusing voltage can be applied to the focusing layer for focusing the free electrons that can be produced in the field effect emitter portion.

In the present application, focusing means, in particular, an influencing of the trajectories of the free electrons such that a spatial distribution of the emitted electrons perpendicularly to the emitting direction is changed, in particular, enlarged and/or reduced. The change can comprise an enlargement of the spatial distribution, also referred to as defocusing and a reduction in the spatial distribution, also referred to as focusing. In other words, the focusing layer is configured for a focusing and a defocusing of the free electrons.

The focusing voltage can be, in particular, between minus 5000 V and plus 5000 V, in particular, between minus 1000 V and plus 1000 V, preferably 200 V or 50 V. The electric potential of the gate electrode is preferably more negative during the electron emission than the electric potential of the focusing layer. The inventors have recognized that advantageously a reduction of the spatial distribution of the electrons, that is, the focusing can be achieved in certain voltage ranges regardless of the sign of the focusing voltage.

The diameter of the gate opening and/or the diameter of the through opening of the second insulating layer and/or the diameter of the through opening of the focusing layer are, in particular, less than 100 μm, preferably less than 25 μm. In particular, the diameter of the gate opening can be less than 10 μm.

The focusing layer is made of an electrically conductive material. The electric conductivity can be achieved by doping the material of the focusing layer and/or can be inherent to the material. For example, the electrically conductive material can be a metal. According to an advantageous embodiment, the focusing layer consists of tungsten in order to have greater thermal loading capacity.

In the present application, the thickness of a layer relates, in particular, to the extent in the emitting direction and/or along the longitudinal central axis of the emitter needle.

A thickness of the first insulating layer is, in particular, greater than a thickness of the gate electrode and/or a thickness of the second insulating layer and/or a thickness of the focusing layer. The thickness of the first insulating layer and/or of the gate electrode and/or of the second insulating layer and/or of the focusing layer is typically constant.

A thickness of the first insulating layer is typically defined by a length of the emitter needle which is often stabilized mechanically by the first insulating layer. The first insulating layer is typically thick enough so that it can insulate the voltage between the field effect emitter portion and the gate electrode. Such a thickness is important, in particular, if the first insulating layer adjoins the inner wall of the gate opening.

A thickness of the gate electrode is, in particular, between 0.01 μm and 25 μm, preferably between 0.1 μm and 2.5 μm and/or is, for example, 0.24 μm. In particular, a thickness of the doped material can be 0.2 μm and the thickness of the cover layer can be 0.04 μm.

A thickness of the second insulating layer is, in particular, between 0.01 μm and 10 μm, preferably between 0.1 μm and 1 μm. The thickness of the second insulating layer is delimited downwardly, in particular, by way of the breakdown strength of the second insulating layer which depends, in particular, upon the material and its thickness and/or dependent upon the maximum focusing voltage. The second insulating layer should preferably be at least thick enough such that the potential difference between the gate electrode and the focusing layer is isolated.

A thickness of the focusing layer is, in particular, between 0.1 μm and 100 μm, preferably between 1 μm and 15 μm. The focusing layer is advantageously as thick as possible in order to be thermally durable in respect of arcing and simultaneously to be able still to pass the free electrons. A thickness of the second insulating layer is preferably greater than a thickness of the gate electrode. A thickness of the focusing layer is preferably less than a thickness of the gate electrode.

An extent of the emitter needle transversely to the longitudinal central axis is, for example, between 0.02 μm and 20 μm, in particular, between 0.05 μm and 1 μm, advantageously 0.2 μm. The first end of the emitter needle can protrude, for example, as far as the center of the thickness of the gate electrode into the gate opening.

The diameter of the gate opening can be, for example, between 0.05 μm and 2 μm, in particular, between 0.1 μm and 1 μm, advantageously 0.34 μm.

The gate opening and/or the through opening of the second insulating layer and/or the through opening of the focusing layer are configured, in particular, rotationally symmetrical. A cross-section of the gate opening and/or of the through opening of the second insulating layer and/or of the through opening of the focusing layer can alternatively be polygonal, in particular rectangular, preferably square.

The central axis of the gate opening and/or of the through opening of the second insulating layer and/or of the through opening of the focusing layer can, in particular, coincide with the longitudinal central axis of the emitter needle. In this case, the longitudinal central axis can, in particular, intersect the gate opening and/or the through opening of the second insulating layer and/or of the through opening of the focusing layer centrally. Alternatively, it is conceivable that the longitudinal central axis has a spacing from the central axis of the gate opening and/or of the through opening of the second insulating layer and/or of the through opening of the focusing layer that is greater than zero and/or encloses an angle of greater than zero.

An embodiment provides that the diameter of the gate opening is smaller than the diameter of the through opening of the focusing layer. This embodiment is advantageous, in particular, since the number of free electrons that are incident upon the focusing layer and are diverted from there via the focusing layer can be reduced. Thus the gate current is preferably reduced. In other words, a portion of the free electrons that can be incident upon the anode is advantageously increased.

An embodiment provides that the diameter of the gate opening is smaller than the diameter of the through opening of the second insulating layer. This embodiment is advantageous, in particular, since a charging of the second insulating layer with electrons which are incident upon the second insulating layer can be reduced. Thus a smaller, or no, electric field that could disrupt the trajectories of the free electrons arises in the second insulating layer.

An embodiment provides that the through opening of the second insulating layer is configured widening in the emitting direction of the emitter needle. In this case, in particular, the diameter of the through opening of the second insulating layer increases with increasing spacing from the gate electrode. This embodiment is advantageous, in particular, since the spatial distribution of the free electrons transversely to the emitting direction increases in the immediate vicinity of the field effect emitter portion. The widening through opening can advantageously compensate for this effect and simultaneously can therein advantageously cover the gate electrode as well as possible and reduce the entry of electrons into the second insulating layer.

A development of the previous embodiment provides that the through opening of the second insulating layer is configured with a truncated cone-shaped inner wall and that the inner wall of the through opening of the second insulating layer encloses an angle with the longitudinal central axis of greater than 0° and less than 60°. This embodiment is advantageous, in particular, since the truncated cone-shaped inner wall can be readily produced and further enables the aforementioned advantages. With this embodiment, typically the through opening of the focusing layer and the gate opening are configured cylindrical. The central axes of the through opening of the focusing layer and of the second insulating layer and the gate opening coincide, in particular, with the longitudinal central axis of the emitter needle. The truncated cone-shaped inner wall of the second insulating layer is typically delimited in the emitting direction from the underside of the focusing layer and/or against the emitting direction, in particular, from the upper side of the gate electrode.

An embodiment provides that the smallest diameter of the through opening of the second insulating layer is greater than the largest diameter of the gate opening. This embodiment is advantageous, in particular, since the second insulating layer cannot interact with electrons propagating parallel to the emitting direction. This embodiment is particularly advantageous in combination with one of the two preceding embodiments in which the through opening of the second insulating layer is configured widening in the emitting direction.

An embodiment provides that the transition of the upper side of the gate electrode to an inner wall of the gate opening is configured arched. An advantage of this embodiment is the reduction of the electric field strength at this transition that is thereby achieved. The transition is, in particular, the, for example, annular edge from the upper side to the inner wall. In other words, in the cross-section parallel to the emitting direction, a corner between the inner wall of the gate opening and the upper side of the gate electrode is arched. Arched means that the gate electrode is processed such that a radius of the transition is enlarged systematically. In other words, a pointedness of the transition is reduced, for example, by way of a rounding. Configured arched means, in particular, produced and/or processed arched.

An embodiment of the present invention provides that the first insulating layer and the second insulating layer adjoin one another through the gate opening. In particular, the first insulating layer can adjoin the second insulating layer and/or the second insulating layer can adjoin the first insulating layer. The first insulating layer and the second insulating layer are connected to one another, in particular, through the gate opening, preferably gaplessly. The first insulating layer and the second insulating layer are connected to one another, in particular, by way of a closed intermediate piece which has a through opening centrally for the emitter needle and/or the free electrons. The intermediate piece can be formed, in particular, annular. Gapless means that at each height of the gate opening in the circumferential direction, material of the first insulating layer and/or of the second insulating layer is situated between the gate opening of the gate electrode. The intermediate piece, dependent upon the manner of observation, the first insulating layer and/or the second insulating layer preferably adjoins the inner wall of the gate opening. In this case, the first insulating layer advantageously consists of the same material as the second insulating layer. This embodiment advantageously improves the insulating capacity of the first insulating layer and the second insulating layer. Advantageously, with this embodiment, a gate current flowing via the gate electrode is reduced.

An embodiment provides that the field effect emitter microstructure has at least one further emitter needle and at least one further gate opening, wherein the longitudinal central axis of the at least one further emitter needle is oriented toward the at least one further gate opening parallel to the emitting direction of the emitter needle. Such a field effect emitter microstructure forms, in particular, an array of field effect emitters. The number of the emitter needles of the field effect emitter microstructure can be greater than two, in particular greater than 100, preferably greater than 10000 or 100000, for example approximately 1000000. The emitter needles and the at least one further emitter needle preferably form an emitting surface for generating a current density of at least 1 A/cm\hat{ }2, advantageously at least 3 A/cm\hat{ }2, particularly advantageously at least 10 A/cm\hat{ }2.

Typically, each emitter needle is associated with a gate opening. The arrangement of the emitter needles relative to the respective gate opening is typically the same. The arrangement of a plurality of emitter needles can be distributed in a plane perpendicularly to the emitting direction. For example, the emitter needles can form a matrix with at least 2×2 per spatial direction. Typically, groups of emitter needles can be switched on and off collectively. It is conceivable that each emitter needle can be switched on and off independently of the other emitter needles. If particular regions of the field effect emitter microstructure can be switched on and off, the field effect emitter microstructure is, in particular, a segmented or pixelated emitter. The gate electrode can have the gate opening and the at least one further gate opening. In this case, the gate electrode is configured coherent, that is, not segmented. Alternatively, the gate electrode can have the gate opening and at least one further gate electrode can have the at least one further gate opening. In this case, an emission voltage and/or different emission voltages can be applied to both the gate electrodes, advantageously independently of one another. It is conceivable to subdivide the first insulating layer and/or the second insulating layer and/or the focusing layer similarly to the gate electrode. It is advantageous for the production, if in particular, the first insulating layer and/or the second insulating layer is configured coherent. For an application of different focusing voltages, it can be advantageous to configure the focusing layer segmented, that is, not coherent. Depending upon the embodiment of the field effect emitter microstructure, the gate electrode and/or the first insulating layer and/or the second insulating layer and/or the focusing layer can be configured coherent or segmented.

The computer program product can be a computer program or can comprise a computer program. The computer program product has, in particular, the program code which form the inventive method steps according to embodiments of the present invention. By this mechanism, the method according to embodiments of the present invention can be carried out in a defined and repeatable manner and monitoring can be carried out via a passing on of the method according to embodiments of the present invention. The computer program product is preferably configured such that the computing unit can carry out the method steps, according to embodiments of the present invention, via the computer program product. The program code can be loaded, in particular, into a memory store of the computing unit and are typically carried out via a processor of the computing unit with access to the memory store. If the computer program product, in particular, the program code, is carried out in the computing unit, typically all the embodiments according to the present invention of the method described can be carried out. The computer program product is, for example, stored on a physical computer-readable medium and/or digitally as a data packet in a computer network. The computer program product can represent the physical, computer-readable medium and/or the data packet in the computer network. One or more example embodiments of the present invention can thus also proceed from the physical computer-readable medium and/or the data packet in the computer network. The physical, computer-readable medium is typically able to be connected directly to the computing unit, for example, in that the physical computer-readable medium is placed in a DVD drive or is inserted into a USB port, whereby the computing unit can access the physical computer-readable medium, in particular to read it. The data packet can preferably be called from the computer network. The computer network can comprise the computing unit or can be indirectly connected via a Wide Area Network (WAN) and/or a (Wireless) Local Area Network connection (WLAN or LAN) to the computing unit. For example, the computer program product can be stored digitally on a cloud server at a storage location of the computer network, and transferred via the WAN via the internet and/or via the WLAN and/or LAN to the computing unit, in particular, by way of the retrieval of a download link which points to the storage location of the computer program product.

Features, advantages or alternative embodiments mentioned in the description of the apparatus are also transferable similarly to the method and vice versa. In other words, claims for the method can be developed with features of the apparatus and vice versa. In particular, the apparatus according to embodiments of the present invention can be used in the method.

Independent of the grammatical term usage, individuals with male, female or other gender identities are included within the term.

### BRIEF DESCRIPTION OF THE DRAWINGS

The present invention will now be described and explained in greater detail making reference to the exemplary embodiments illustrated in the drawings. In principle, structures and items which remain essentially the same are identified in the following description of the figures with the same reference signs as on the first occurrence of the relevant structure or item.

In the drawings:

FIG. 1 shows a first variant of the field effect emitter microstructure according to embodiments of the present invention,

FIG. 2 shows a second variant of the field effect emitter microstructure according to embodiments of the present invention,

FIG. 3 shows a third variant of the field effect emitter microstructure according to embodiments of the present invention,

FIG. 4 shows a first exemplary embodiment of the field effect emitter microstructure,

FIG. 5 shows a second exemplary embodiment of the field effect emitter microstructure,

FIG. 6 shows a third exemplary embodiment of the field effect emitter microstructure,

FIG. 7 shows an electron emitter apparatus according to embodiments of the present invention,

FIG. 8 shows an X-ray tube according to embodiments of the present invention,

FIG. 9 shows a method, according to embodiments of the present invention, for generating X-ray beams via an X-ray tube, and

FIG. 10 shows a first exemplary embodiment of the method.

### DETAILED DESCRIPTION

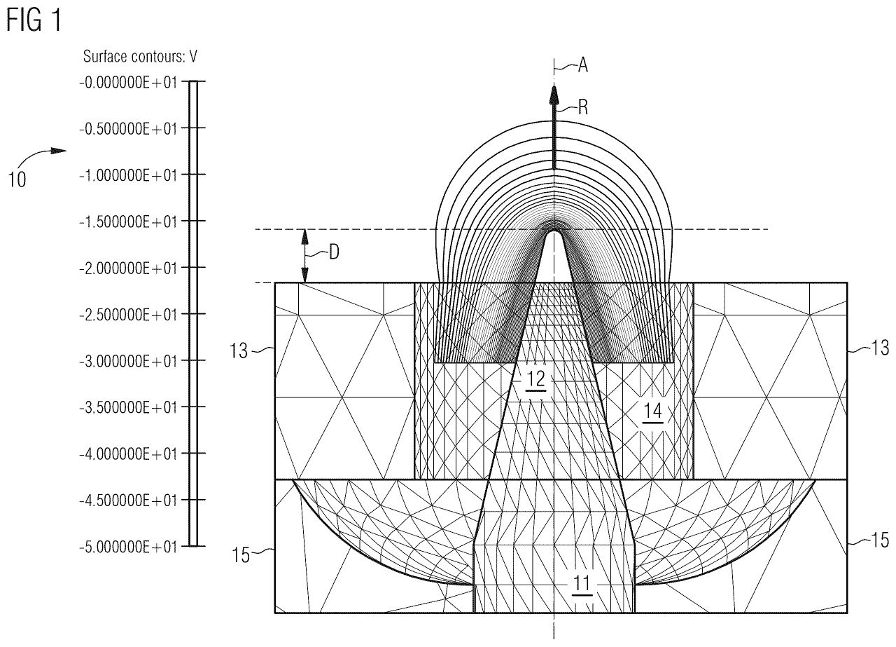

FIG. 1 shows a first variant of the field effect emitter microstructure 10, according to embodiments of the present invention, in a longitudinal section in the emitting direction R.

The field effect emitter microstructure 10 has an emitter needle 11. The emitter needle 11 has a field effect emitter portion 12 on a first end.

The field effect emitter microstructure 10 further has a gate electrode 13 with a gate opening 14. The gate opening 14 connects an underside of the gate electrode 13 that faces toward the emitter needle 11 to an upper side of the gate electrode 13 that faces away from the underside. The longitudinal central axis A of the emitter needle 11 is oriented perpendicularly to the gate electrode 13 toward the gate opening 14 in the emitting direction R.

The field effect emitter microstructure 10 further has a first insulating layer 15. The first insulating layer 15 adjoins the emitter needle 11 at least underneath the field effect emitter portion 12 and at least partially adjoins the underside of the gate electrode 13. Via an emission voltage that can be applied between the gate electrode 13 and the field effect emitter portion 12, free electrons can be produced in the field effect emitter portion 12.

The first end of the emitter needle 11 has a protrusion D greater than zero relative to the upper side of the gate electrode 13. The protrusion D is between 0.001 μm and 1 μm, in particular, between 0.01 μm and 0.4 μm.

The emitter needle 11 has a pointed portion. The field effect emitter portion 12 is part of the pointed portion. The pointed end of the pointed portion is arranged above the upper side of the gate electrode 13. The broad end of the pointed portion facing away from the pointed end is arranged underneath the underside of the gate electrode 13.

In FIG. 1, a diameter of the emitter needle 11 is smaller than a diameter of the gate opening 14. The gate opening 14 is arranged centered about the longitudinal central axis A and has a constant diameter.

The first insulating layer 15 does not adjoin the inner wall of the gate opening 14 nor on the sides of the field effect emitter portion 12. The first insulating layer 15 has a cut-out with a partially constant cross-section in which the emitter needle 11 is arranged. The first insulating layer 15 has a cut-out at the height of the field effect emitter portion 12 with a portion having a larger diameter than a portion underneath the field effect emitter portion 12.

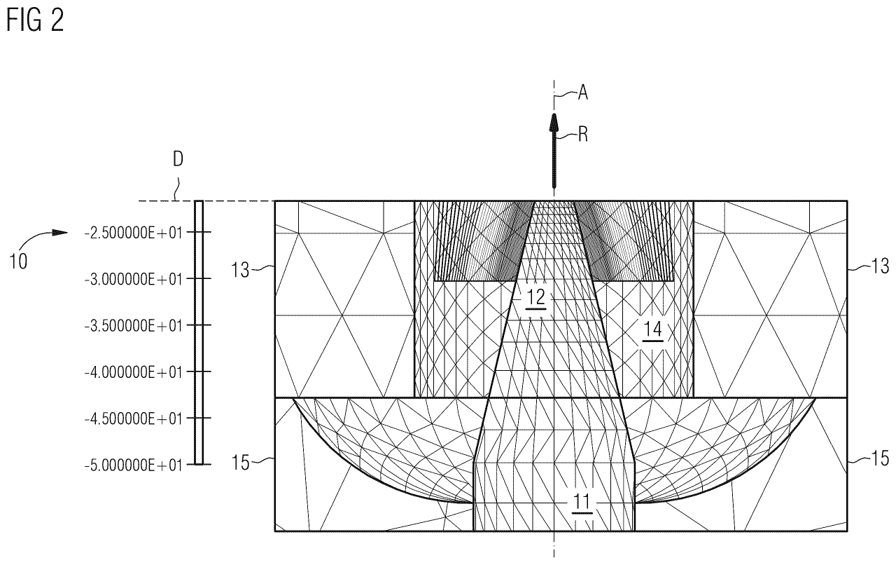

FIG. 2 shows a second variant of the field effect emitter microstructure 10, according to embodiments of the present invention, in a longitudinal section in the emitting direction R.

The first end of the emitter needle 11 has a protrusion D equal to zero relative to the upper side of the gate electrode 13. Thus, the first end of the emitter needle 11 ends flush with the upper side of the gate electrode 13.

In FIG. 2, for reasons of clarity, the emitter needle 11 is shown truncated by the part that, in FIG. 1, protrudes beyond the upper side of the gate electrode 13. Rather than removing the protruding part, alternatively the emitter needle 11 can be arranged deeper and flush with the upper side of the gate electrode 13.

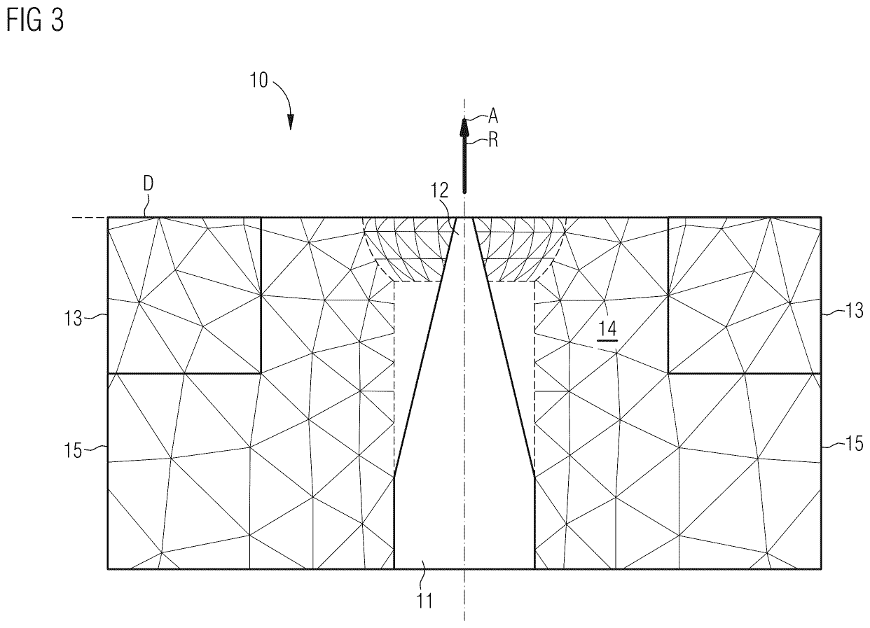

FIG. 3 shows a third variant of the field effect emitter microstructure 10, according to embodiments of the present invention, in a longitudinal section in the emitting direction R.

The first insulating layer 15 adjoins an inner wall of the gate opening 14. The first insulating layer 15 additionally adjoins the sides of the field effect emitter portion 12. Therefore the entire gate opening 14 is filled with the first insulating layer 15. The field effect emitter portion 12 is completely embedded in the first insulating layer 15.

The first end of the emitter needle 11 has a protrusion D equal to zero relative to the upper side of the gate electrode 13. Thus, the first end of the emitter needle 11 ends flush with the upper side of the gate electrode 13.

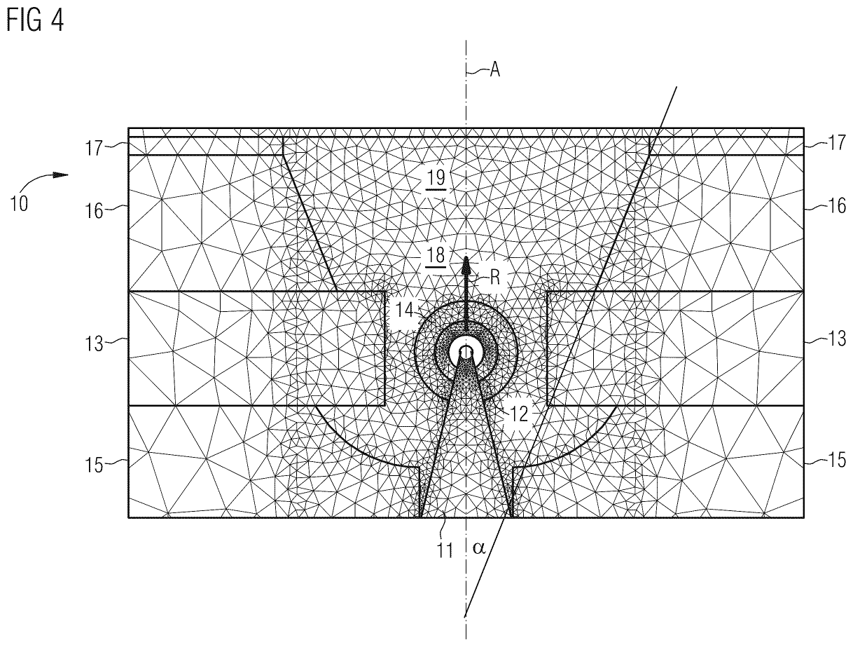

FIG. 4 shows a first exemplary embodiment of the field effect emitter microstructure 10 in a longitudinal section along the emitting direction R.

The first end of the emitter needle 11 has no protrusion D greater than or equal to zero relative to the upper side of the gate electrode 13. The upper side of the gate electrode 13 has a protrusion greater than zero relative to the first end of the emitter needle 11. Not shown in FIG. 4 is that the first insulating layer 15 adjoins an inner wall of the gate opening 14.

The field effect emitter microstructure 10 further has a second insulating layer 16. The second insulating layer 16 has an underside facing toward the emitter needle 11 and an upper side facing away from the underside.

The field effect emitter microstructure 10 further has an electrically conductive focusing layer 17. The electrically conductive focusing layer 17 has an underside facing toward the emitter needle 11 and an upper side facing away from the underside.

The underside of the second insulating layer 16 at least partially adjoins the upper side of the gate electrode 13. The upper side of the second insulating layer 16 at least partially adjoins the underside of the focusing layer 17. The second insulating layer 16 and the focusing layer 17 each have a through opening 18, 19 for the free electrons that can be produced in the field effect emitter portion 12.

In FIG. 4, a diameter of the emitter needle 11 is smaller than a diameter of the gate opening 14 and than a diameter of the through openings 18, 19. The gate opening 14 and the through openings 18, 19 are arranged centered about the longitudinal central axis A. The diameter of the gate opening 14 is smaller than the diameter of the through opening 19 of the focusing layer 17. The diameter of the gate opening 14 is smaller than the diameter of the through opening 18 of the second insulating layer 16. The smallest diameter of the through opening 18 of the second insulating layer 16 is greater than the largest diameter of the gate opening 14.

The through opening 18 of the second insulating layer 16 is configured widening in the emitting direction R of the emitter needle 11. The through opening 18 of the second insulating layer 16 is configured having a truncated cone-shaped inner wall. The inner wall of the through opening 18 of the second insulating layer 16 encloses an angle α with the longitudinal central axis A of greater than 0° and less than 60°. The transition of the upper side of the gate electrode 13 to the inner wall of the gate opening 14 is configured arched.

Advantageously, the second insulating layer 16 has a breakdown strength of at least 100 V/μm, preferably at least 400 V/μm. The focusing layer 17 can consist of tungsten.

FIG. 5 shows a second exemplary embodiment of the field effect emitter microstructure 10 in a longitudinal section along the emitting direction R.

The first insulating layer 15 and the second insulating layer 16 adjoin one another through the gate opening 14. As shown in FIG. 5, the entire gate opening 14 can be completely filled with the first insulating layer 15 and/or the second insulating layer 16 and with the emitter needle 11. It is alternatively conceivable that the gate opening 14 is not completely filled with the first insulating layer 15 and/or the second insulating layer 16.

In FIG. 5, the first end of the emitter needle 11 has a protrusion D of greater than zero relative to the upper side of the gate electrode 13. In particular, the field effect emitter portion 12 has a protrusion of greater than zero relative to the upper side of the gate electrode 13. In other words, the emitter needle 11 protrudes out of the gate opening 14 and/or through the gate opening 14.

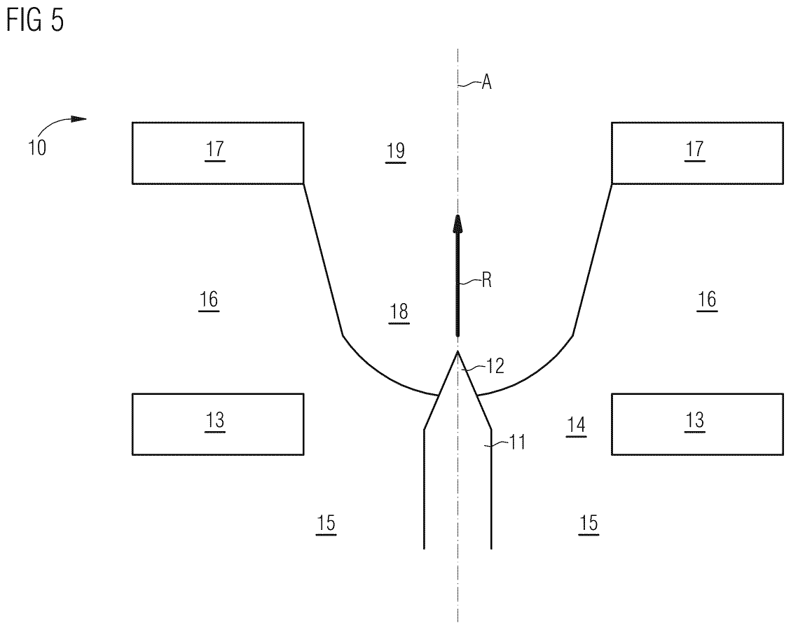

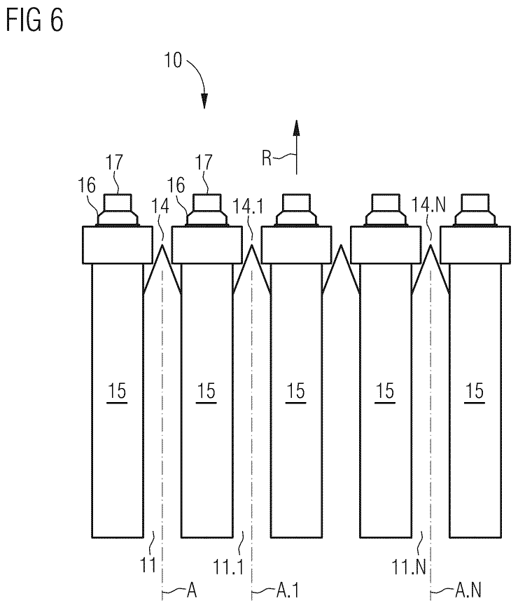

FIG. 6 shows a third exemplary embodiment of the field effect emitter microstructure 10 in a longitudinal section along the emitting direction R. The representation in FIG. 6 is not to scale.

The field effect emitter microstructure 10 has at least one further emitter needle 11.1, . . . 11.N and at least one further gate opening 14.1, . . . 14.N. The longitudinal central axis A.1, . . . . A.N of the at least one further emitter needle 11.1, . . . 11.N is oriented toward the at least one further gate opening 14.1, . . . 14.N parallel to the emitting direction R of the emitter needle 11.

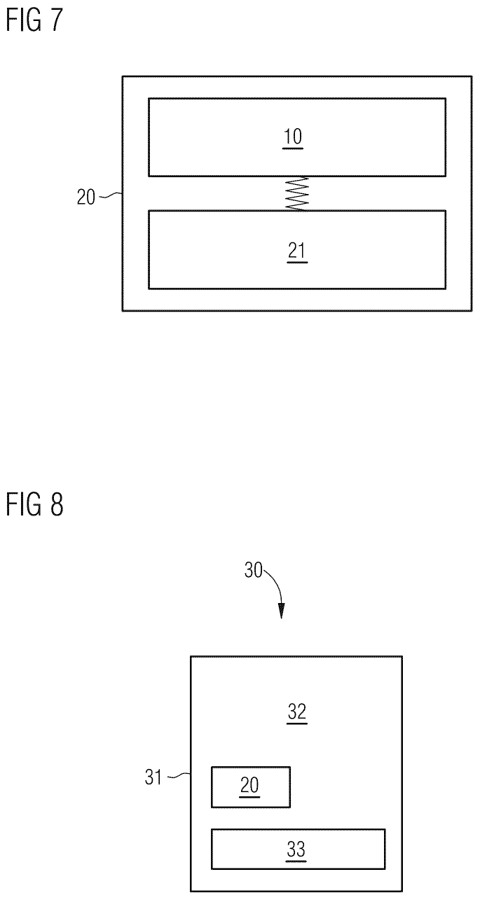

FIG. 7 shows an electron emitter apparatus 20 according to embodiments of the present invention in a block circuit diagram.

The electron emitter apparatus 20 has a field effect emitter microstructure 10 and a voltage source 21. The voltage source 21 is connected to the field effect emitter microstructure 10 for providing an emission voltage and/or a focusing voltage.

FIG. 8 shows an X-ray tube 30 according to embodiments of the present invention in a block circuit diagram.

The X-ray tube 30 has a housing 31. The housing 31 has an internal space 32 which can be evacuated.

The X-ray tube 30 also has an electron emitter apparatus 20. The electron emitter apparatus 20 is arranged in the internal space 32.

The X-ray tube 30 also has an anode 33. The anode 33 is arranged in the internal space 32 and is configured for generating X-ray beams dependent upon free electrons that can be produced via the electron emitter apparatus 20.

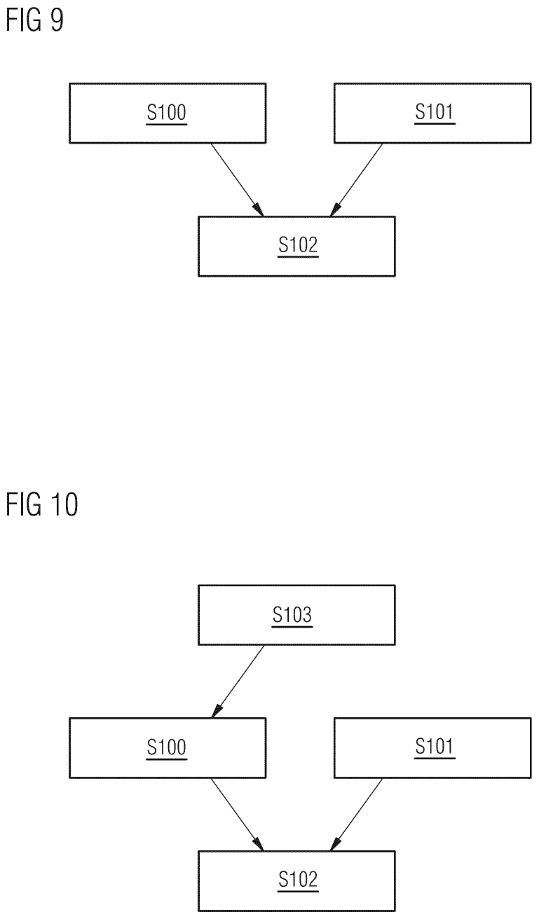

FIG. 9 shows a method according to embodiments of the present invention for generating X-ray beams via an X-ray tube, in a flow diagram.

The method step S100 denotes an application of an emission voltage between the gate electrode 13 and the emitter needle 11 for producing free electrons.

The method step S101 denotes an application of a focusing voltage between the focusing layer 17 and the gate electrode 13 for focusing the free electrons.

The method step S102 denotes a generation of X-ray beams via the anode 33 of the X-ray tube 30 by way of an interaction with the focused free electrons.

FIG. 10 shows a first exemplary embodiment of the method for generating X-ray beams via an X-ray tube, in a flow diagram with an additional method step S103, wherein before the emission voltage, a voltage is applied between the gate electrode and the emitter needle for a burning free of at least a part of the field effect emitter portion.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be implemented using hardware, software, and/or a combination thereof. For example, hardware devices may be implemented using processing circuitry such as, but not limited to, a processor, Central Processing Unit (CPU), a Graphics Processing Unit (GPU), a controller, an arithmetic logic unit (ALU), a digital signal processor, a microcomputer, a field programmable gate array (FPGA), a System-on-Chip (Soc), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one example embodiment relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer. Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Although the present invention has been illustrated and described in detail by way of the preferred exemplary embodiments, the present invention is nevertheless not restricted by the examples given and other variations can be derived therefrom by a person skilled in the art without departing from the protective scope of the present invention.

What is claimed is:

1. A field effect emitter microstructure for an X-ray tube, the field effect emitter microstructure comprising:
an emitter needle having a field effect emitter portion on a first end;
a gate electrode with a gate opening, wherein the gate opening connects an underside of the gate electrode that faces toward the emitter needle to an upper side of the gate electrode that faces away from the underside of the gate electrode, wherein a longitudinal central axis of the emitter needle is oriented perpendicularly to the gate electrode toward the gate opening in an emitting direction; and
a first insulating layer adjoining the emitter needle at least under the field effect emitter portion and at least partially adjoining the underside of the gate electrode, wherein
via an emission voltage applied between the gate electrode and the field effect emitter portion, free electrons are produced in the field effect emitter portion, and
at least one of (i) the first end of the emitter needle has a protrusion greater than or equal to zero relative to the upper side of the gate electrode, or (ii) the first insulating layer adjoins an inner wall of the gate opening.

2. The field effect emitter microstructure as claimed in claim 1, wherein the first insulating layer adjoins sides of the field effect emitter portion.

3. The field effect emitter microstructure as claimed in claim 1, wherein the first insulating layer has a cut-out with a partially constant cross-section in which the emitter needle is arranged.

4. The field effect emitter microstructure as claimed in claim 1, wherein the first insulating layer has a cut-out at a height of the field effect emitter portion with a portion having a larger diameter than a portion under the field effect emitter portion.

5. The field effect emitter microstructure as claimed in claim 1, wherein the field effect emitter portion is completely embedded in the first insulating layer.

6. The field effect emitter microstructure as claimed in claim 1, wherein the protrusion is between 0.001 μm and 1 μm.

7. The field effect emitter microstructure as claimed in claim 1, wherein
the emitter needle has a pointed portion,
the field effect emitter portion is part of the pointed portion,
a pointed end of the pointed portion is arranged above the upper side of the gate electrode, and
a broad end of the pointed portion that faces away from the pointed end is arranged under the underside of the gate electrode.

8. The field effect emitter microstructure as claimed in claim 1, further comprising:
a second insulating layer with an underside facing toward the emitter needle and an upper side facing away from the underside; and
an electrically conductive focusing layer with an underside facing toward the emitter needle and an upper side facing away from the underside, wherein
the underside of the second insulating layer at least partially adjoins the upper side of the gate electrode,
the upper side of the second insulating layer at least partially adjoins the underside of the electrically conductive focusing layer, and
the second insulating layer and the electrically conductive focusing layer each have a through opening for the free electrons produced in the field effect emitter portion.

9. The field effect emitter microstructure as claimed in claim 8, wherein the first insulating layer and the second insulating layer adjoin one another through the gate opening.

10. The field effect emitter microstructure as claimed in claim 8, wherein the through opening of the second insulating layer widens in the emitting direction of the emitter needle.

11. The field effect emitter microstructure as claimed in claim 1, wherein
the field effect emitter microstructure has at least one further emitter needle and at least one further gate opening, and
a longitudinal central axis of the at least one further emitter needle is oriented toward the at least one further gate opening parallel to the emitting direction of the emitter needle.

12. An electron emitter apparatus, comprising:
the field effect emitter microstructure as claimed in claim 1; and
a voltage source connected to the field effect emitter microstructure, the voltage source configured to provide at least one of the emission voltage or a focusing voltage.

13. An X-ray tube, comprising:
a housing with an internal space configured to be evacuated;
the electron emitter apparatus as claimed in claim 12, in the internal space; and
an anode in the internal space, the anode configured to generate X-ray beams dependent upon the free electrons produced via the electron emitter apparatus.

14. A method for generating X-ray beams via the X-ray tube as claimed in claim 13, the method comprising:
applying the emission voltage between the gate electrode and the emitter needle to produce the free electrons;
applying a focusing voltage between an electrically conductive focusing layer and the gate electrode to focus the free electrons; and
generating X-ray beams via the anode of the X-ray tube by way of an interaction with the focused free electrons.

15. The method as claimed in claim 14, wherein before applying the emission voltage, the method comprises:
applying a voltage between the gate electrode and the emitter needle for a burning free of at least a part of the field effect emitter portion.

16. The field effect emitter microstructure as claimed in claim 2, wherein the first insulating layer has a cut-out with a partially constant cross-section in which the emitter needle is arranged.

17. The field effect emitter microstructure as claimed in claim 16, wherein the first insulating layer has a cut-out at a height of the field effect emitter portion with a portion having a larger diameter than a portion under the field effect emitter portion.

18. The field effect emitter microstructure as claimed in claim 17, wherein
the emitter needle has a pointed portion,
the field effect emitter portion is part of the pointed portion,
a pointed end of the pointed portion is arranged above the upper side of the gate electrode, and
a broad end of the pointed portion that faces away from the pointed end is arranged under the underside of the gate electrode.

19. The field effect emitter microstructure as claimed in claim 2, wherein
the emitter needle has a pointed portion,
the field effect emitter portion is part of the pointed portion,
a pointed end of the pointed portion is arranged above the upper side of the gate electrode, and
a broad end of the pointed portion that faces away from the pointed end is arranged under the underside of the gate electrode.

20. The field effect emitter microstructure as claimed in claim 2, further comprising:
a second insulating layer with an underside facing toward the emitter needle and an upper side facing away from the underside; and
an electrically conductive focusing layer with an underside facing toward the emitter needle and an upper side facing away from the underside, wherein
the underside of the second insulating layer at least partially adjoins the upper side of the gate electrode,
the upper side of the second insulating layer at least partially adjoins the underside of the electrically conductive focusing layer, and
the second insulating layer and the electrically conductive focusing layer each have a through opening for the free electrons produced in the field effect emitter portion.
